(19) United States
(12) Patent Application Publication
(10) Pub. No.: US 2019/0228435 A1
(43) Pub. Date: Jul. 25, 2019

(54) LOCATION TYPE CONFIDENCE OPTIMIZATION

(71) Applicant: INTERNATIONAL BUSINESS MACHINES CORPORATION, Armonk, NY (US)

(72) Inventors: Lisa Seacat DELUCA, Baltimore, MD (US); Jeremy A. GREENBERGER, Raleigh, NC (US)

(21) Appl. No.: 15/876,577

(22) Filed: Jan. 22, 2018

(51) Int. Cl. G06Q 30/02; H04W 4/021

(52) U.S. Cl. CPC G06Q 30/0261; H04W 4/021; G06Q 30/0259

(57) ABSTRACT

Methods, computer program products, and systems are presented. The methods include, for instance: obtaining, by one or more processor, a geographical coordinate of a mobile device according to a location event, as a user carrying the mobile device travels. An address corresponding to the geographical coordinates is ascertained and the address is searched against a location database. Based on contents searched from the location database, a confidence score for the type of the location is determined and a notification corresponding to the type is generated and sent to the user.

### TECHNICAL FIELD

The present disclosure relates to mobile marketing technology, and more particularly to methods, computer program products, and systems for optimizing confidence score on a type of a location.

### BACKGROUND

In conventional geofencing, a geometric boundary around a geographical point is defined by a pair of latitudinal and longitudinal coordinates, and a range. The geofencing may be utilized as a kind of location marketing, for marketing campaigns based on characterization of the geographical point. The effectiveness of location marketing campaigns depends on accurate classification of the geographical point for each user, as measured in getting more responses and getting accepted with more suggestions made in notifications.

### SUMMARY

The shortcomings of the prior art are overcome, and additional advantages are provided, through the provision, in one aspect, of a method. The method for optimizing a confidence score for a location visited by a user carrying a mobile device, includes, for instance: obtaining, by one or more processor, a geographical coordinates of the mobile device, where the geographical coordinates indicating a location event in relation with the location and the mobile device; acquiring an address from the geographical coordinates of the location event; searching a location database for the address; analyzing one or more result from the searching; determining a confidence score indicating a likelihood on a type of the location, based on the analyzing; and sending a notification for the location to the user, where the notification is generated based on the confidence score on the type of the location.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for improving accuracy assessing individual interest in location events, in accordance with one or more embodiments set forth herein;

FIG. 2 depicts a flowchart of operations performed by the confidence optimization engine, in accordance with one or more embodiments set forth herein;

FIG. 3 depicts a computing node according to one embodiment;

FIG. 4 depicts a cloud computing environment according to an embodiment of the present invention; and

FIG. 5 depicts abstraction model layers according to an embodiment of the present invention.

### DETAILED DESCRIPTION

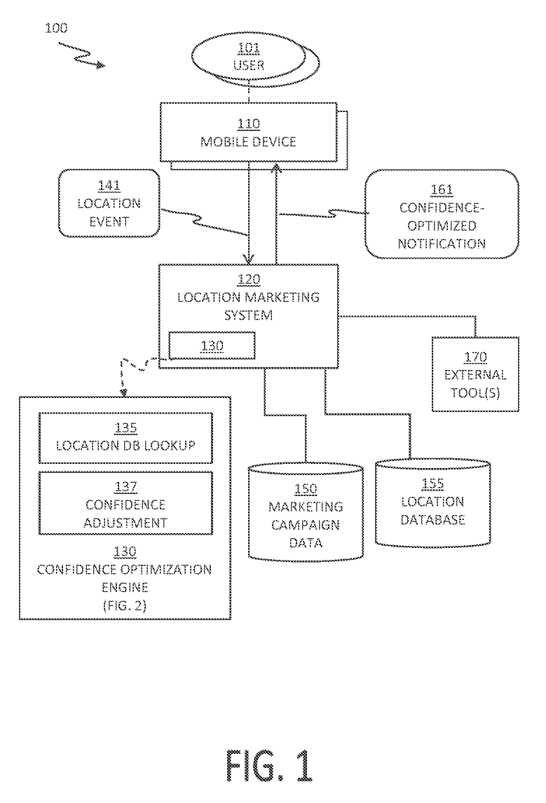

FIG. 1 depicts a system 100 for improving accuracy in assessing individual interest in certain locations, in accordance with one or more embodiments set forth herein.

The system 100 includes a location marketing system 120 runs in a venue. The location marketing system 120 receives a location event 141 from a mobile device 110 of a user 101, as the user 101 moves around and generates location events.

The location marketing system 120 includes a confidence optimization engine 130. The location marketing system 120 is coupled to a marketing campaign database 150, a location database 155, and one or more external tool 170. The location database 155 includes a plurality of Point of Interest (POI) descriptions, including addresses and respectively corresponding types of business. Examples of the location database 155 may include, but are not limited to, a business directory of a digitized phone book, Internet map and various shop review data. The location database 155 may be automatically established by machine learning, based on various directory databases. The marketing campaign database 150 stores predefined geofences per venue, predefined marketing campaign strategies, notification templates, and various control parameters for marketing campaigns per venue classes, per target user groups, etc. Based on the location event 141, application content from the marketing campaign database 150, and lookup results from the location database 155, the location marketing system 120 creates a location-based notification.

The confidence optimization engine 130 includes a location database lookup process 135 and a confidence adjustment process 137. The confidence optimization engine 130 converts coordinates of the location event 141 to an address, looks up the address from the location database 155, determines a confidence score of a type of the location based on information discovered in the location database 155, and adjusts dynamically the confidence score based on update from the location database 155.

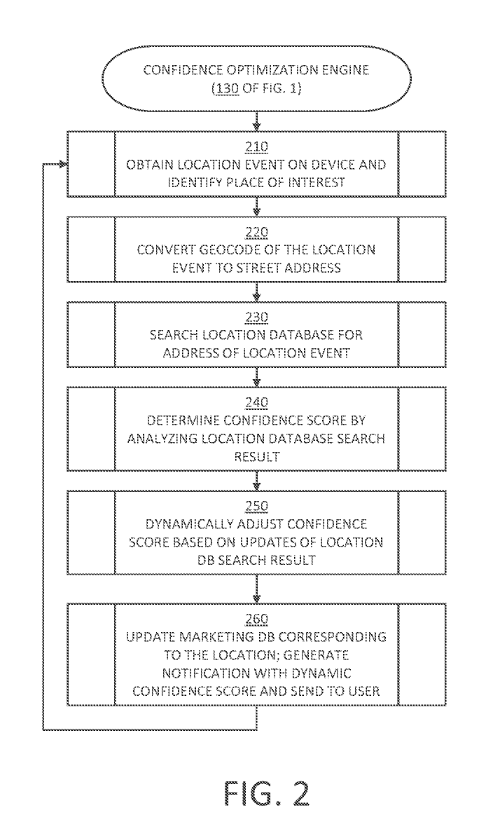

The location marketing system 120 keeps the marketing campaign database 150 up to date, accordingly with the adjusted confidence scores for respective locations. The location marketing system 120 generates and sends the confidence-optimized notification 161 to the mobile device 110, when conditions for notification as set forth in the marketing campaign database 150 are satisfied. Detailed operations of the confidence optimization engine 130 are presented in FIG. 2 and corresponding description.

FIG. 2 depicts a flowchart of operations performed by the confidence optimization engine 130 of FIG. 1, in accordance with one or more embodiments set forth herein.

In block 210, the confidence optimization engine 130 obtains the location event 141 on the mobile device 110 of the user 101. The location event 141 is generated by the mobile device upon detecting a certain condition, including interacting with a venue running the location marketing system 120. The location marketing system 120 monitors traffics of mobile devices in relation with a venue boundary, or a geofence, for a location event. An example of the location marketing system may include, but are not limited to, IBM Marketing Cloud. As in certain examples of existing location marketing systems, the location marketing system 120 supports detection for places of interest for respective users with the location event 141. Then the confidence optimization engine 130 proceeds with block 220.

A geofence around a geographical point is often used to define a boundary of a venue. Geofences are used to enhance mobile applications, in determining when to push a marketing notification to a user by monitoring when the user is near a store, and/or in turning home lights on and off when a family is away by tracking device location in home automation/security systems. In e-commerce applications, tracking respective mobile devices as each user travels may be utilized as a dynamic personalized geofence, for the purpose of when and what kind of marketing notifications may be pushed to the mobile devices for maximum marketing responses.

Examples of location events with respect to a geofence may be: Dwell in; Entry into; and Exit from, for example, a 1-mile radius boundary from a train station. In certain embodiments of the present invention, the location events may be generates based on intersecting venue geofences and a personal geofence around the mobile device of the user. A size of the personal geofence may be dynamically adjusted according to various parameters, such as a text message, a location specified for a calendar event, etc.

The places of interest for an individual user may be determined based on preconfigured parameter, based on patterns of hours spent on the location, hourly patterns indicating the time of the day, and frequencies of visits, etc., respective to types of locations. The places of interest subject to adjustment of a confidence score may be locations the user frequently visits but not dwells for hours such as stores of various categories, restaurants, coffee shops, banks, gyms, cleaners, daycares, etc.

In certain embodiments of the present invention, a personalized geofence around the mobile device may be set and a reach of the mobile device may be recorded to establish a historical travel pattern of the user 101.

Other certain embodiments of the present invention, the places of interest may be identified by interrelating the location of the mobile device with message contents in order to adjust a size of the personalized geofence around the mobile device accordingly. For example, a normal radius of 100 feet of the personalized geofence radius may be extended to a 2-mile radius, when a text message of “On my way. 3 minutes away” is sent to a known contact while the mobile device is coupled to a moving vehicle.

In block 220, the confidence optimization engine 130 converts a geocode of the location event from block 210 to a street address, or an address. Then the confidence optimization engine 130 proceeds with block 230.

In block 230, the confidence optimization engine 130 searches the location database for the street address of the location event. The location database may be a combination of Internet/web pages, a business directory of a digital phone book, business venue listings in web map services, etc. For example, as in Internet map searches, the confidence optimization engine 130 searches the street address of the location event and discovers that the street address corresponds to an apartment complex. Then the confidence optimization engine 130 proceeds with block 240.

In identifying places of interest, existing mobile device location utilities analyze location event patterns such as, a daytime dwelling location is work, and a nighttime dwelling location is home. The existing mobile device location utilities fail to register locations the user frequently visits but not dwells for hours, such as stores, restaurants, shops, banks, gyms, cleaners, daycares. Because such places may be where the most commercial activities are conducted, and because the users may be interested in push notifications from such locations, identifying places visited for a short time as customized places of interest for the user would contribute to the efficiency of the location marketing system 120. The confidence optimization engine 130 accurately classify types of such shortly visited locations by searching the location database for the respective addresses of such locations.

In block 240, the confidence optimization engine 130 determine a confidence score on a type of a location corresponding to the street address, by analyzing search results from block 230. Then the confidence optimization engine 130 proceeds with block 250.

In block 250, the confidence optimization engine 130 dynamically adjusts the confidence score from block 240 based on updates of the location database search results. Then the confidence optimization engine 130 proceeds with block 260.

The confidence optimization engine 130 may register shortly visited locations as favorite places for the user 101, keeps the latest information on the favorite places for the user 101, and keeps track of location event patterns for such favorite places. As a result, upon being consented by the user 101, the location marketing system 120 may send notifications engaging the user 101 with activities offered at the favorite places with respect to location events regarding home and/or work.

In block 260, the confidence optimization engine 130 updates a confidence score and a location type corresponding to the location as stored in the marketing campaign database 150. The confidence optimization engine 130 generates a notification for the location as a personalized marketing campaign based on a dynamic confidence score, and send the notification to the user. Then the confidence optimization engine 130 terminates processing the location event obtained in block 220.

Certain embodiments of the present invention may offer various technical computing advantages, including contextual analysis on a location event of a mobile device. A geographical coordinate, or a geocode, associated with the location event of the mobile device is converted to a street address. The confidence optimization engine looks up the address from the location database, and based on a search result for the address, determines a confidence score on a type of the location. The confidence score for the location may be dynamically updated according to updates in content of the location database. The location database may be maintained by use of machine learning. The confidence optimization may identify certain places preferred by a user of the mobile device, and accordingly, may provide opportunities for targeted marketing campaign for respective locations. By use of multithreading and/or multiprocessing, the confidence optimization service may be concurrently rendered for any number of users in the serviced environment. Certain embodiments of the present invention may be implemented by use of a cloud platform/data center in various types including a Software-as-a-Service (SaaS), Platform-as-a-Service (PaaS), Database-as-a-Service (DBaaS), and combinations thereof based on types of subscription. The confidence optimization service may be provided for subscribed business entities in need from any location in the world.

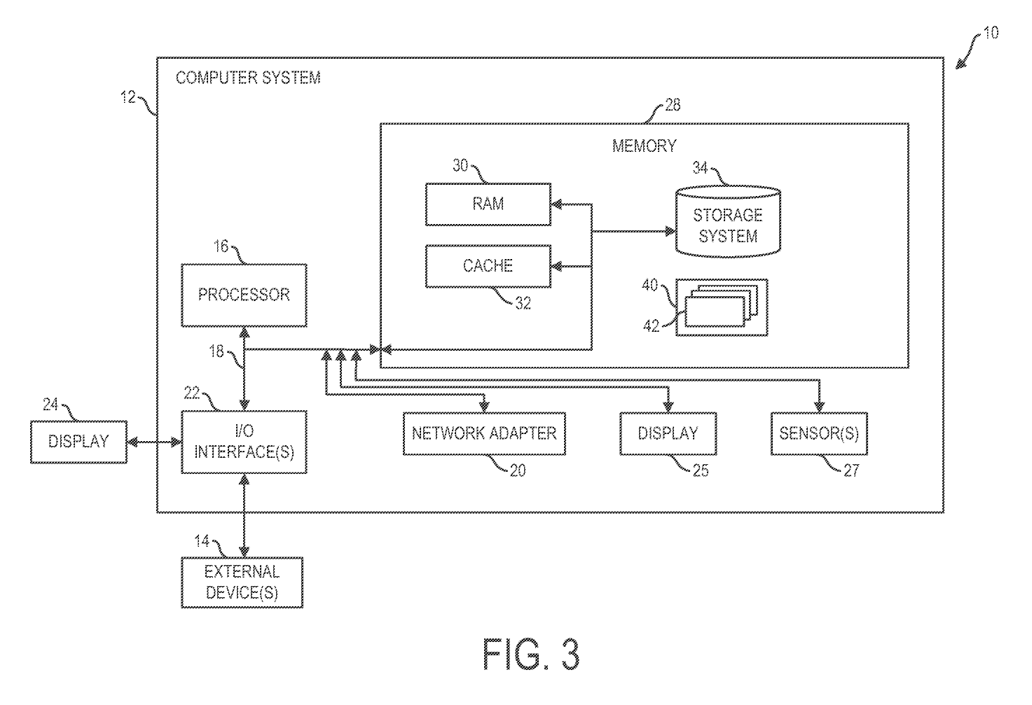

FIGS. 3-5 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments herein are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities may be rapidly and elastically provisioned, in some cases automatically, to quickly scale out and rapidly released to quickly scale in. To the consumer, the capabilities available for provisioning often appear to be unlimited and may be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage may be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 may be implemented as a cloud computing node in a cloud computing environment, or may be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

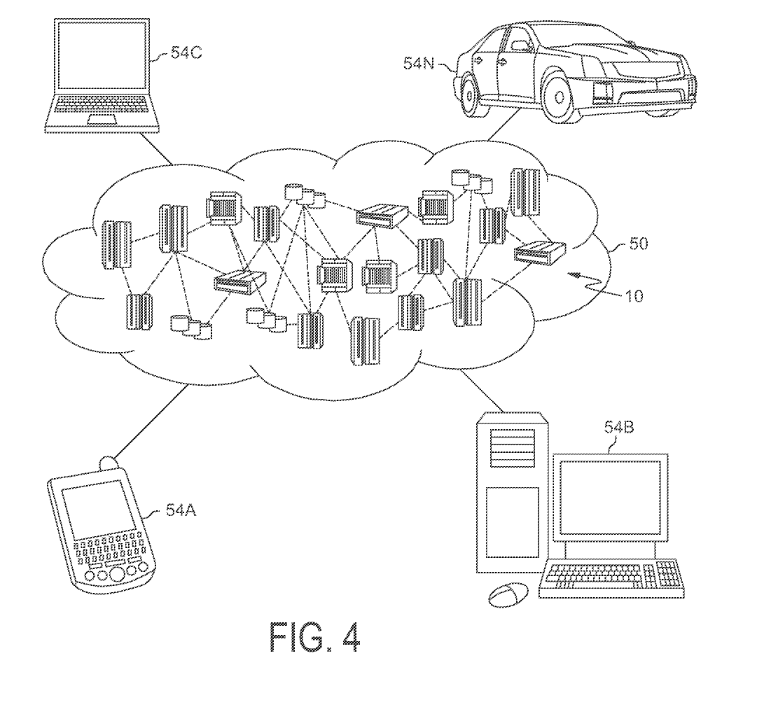

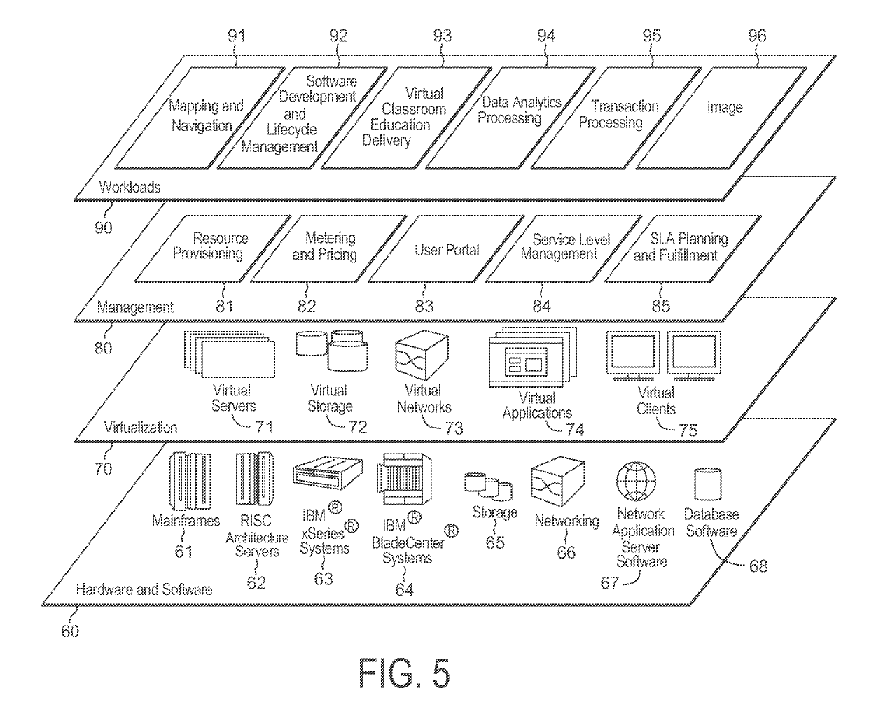

As shown in FIG. 3, computer system 12 in computing node 10 is shown in the form of a general-purpose computing device. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 4-5.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein. In one embodiment, the location marketing system 120 can include one or more computing node 10 and can include one or more program 40 for performing functions described with reference to various methods as are set forth herein such as the method described in connection with the flowchart of FIG. 2. In one embodiment, the respective components of FIG. 1 that are referenced with differentiated reference numerals may each be computing node based devices and each may include one or more computing node 10 and may include one or more program 40 for performing functions described herein with reference to the respective components.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which may be configured to provide user interface functionality, computing node 10 in one embodiment can include display 25 connected to bus 18. In one embodiment, display 25 may be configured as a touch screen display and may be configured to provide user interface functionality, e.g. can facilitate virtual keyboard functionality and input of total data. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and may be configured to provide a location of computing node 10. In one embodiment, one or more sensor device 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapter 20. In FIG. 4 computing node 10 is described as being implemented in a cloud computing environment and accordingly is referred to as a cloud computing node in the context of FIG. 4.

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for confidence optimization as set forth herein. The processing components 96 may be implemented with use of one or more program 40 described in FIG. 3.

The present invention may be a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements may be practiced with less than or greater than the certain number of elements. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for optimizing a confidence score for a location visited by a user carrying a mobile device, comprising:
obtaining, by one or more processor, a geographical coordinates of the mobile device, wherein the geographical coordinates indicating a location event in relation with the location and the mobile device;
acquiring an address from the geographical coordinates of the location event;
searching a location database for the address;
analyzing one or more result from the searching;
determining a confidence score indicating a likelihood on a type of the location, based on the analyzing; and
sending a notification for the location to the user, wherein the notification is generated based on the confidence score on the type of the location.

2. The computer implemented method of claim 1, further comprising:
identifying a place of interest for the user, based on the location and a personalized geofence of the user.

3. The computer implemented method of claim 2, wherein the personalized geofence of the user is a predefined geometric range from the mobile device, and wherein the place of interest may be determined based on a frequency of visits to the location, a time of the day for the visits, and hours spent on the location.

4. The computer implemented method of claim 1, the determining comprising:
adjusting the confidence score on the type of the location according to content relevant to the address from the location database, based on ascertaining updates of the location database on the content relevant to the address.

5. The computer implemented method of claim 1, wherein the location database includes a plurality of addresses including the address, and a type of location associated with the address, and wherein, the type of location corresponds to a type of business of the location.

6. The computer implemented method of claim 1, wherein the location event may be selected from the group consisting of: Dwell-in a boundary of the location; Entry-into the boundary; and Exit-from the boundary, and wherein the boundary is a geometrical enclosure around the location including the location.

7. The computer implemented method of claim 1, wherein the notification is preconfigured in a marketing campaign database, and wherein the notification promotes a business transaction according to the type of the location with the confidence score as ascertained by use of the location database.

8. A computer program product comprising:
a computer readable storage medium readable by one or more processor and storing instructions for execution by the one or more processor for performing a method for optimizing a confidence score for a location visited by a user carrying a mobile device, comprising:
obtaining a geographical coordinates of the mobile device, wherein the geographical coordinates indicating a location event in relation with the location and the mobile device;
acquiring an address from the geographical coordinates of the location event;
searching a location database for the address;
analyzing one or more result from the searching;
determining a confidence score indicating a likelihood on a type of the location, based on the analyzing; and
sending a notification for the location to the user, wherein the notification is generated based on the confidence score on the type of the location.

9. The computer program product of claim 8, further comprising:
identifying a place of interest for the user, based on the location and a personalized geofence of the user.

10. The computer program product of claim 9, wherein the personalized geofence of the user is a predefined geometric range from the mobile device, and wherein the place of interest may be determined based on a frequency of visits to the location, a time of the day for the visits, and hours spent on the location.

11. The computer program product of claim 8, the determining comprising:
adjusting the confidence score on the type of the location according to content relevant to the address from the location database, based on ascertaining updates of the location database on the content relevant to the address.

12. The computer program product of claim 8, wherein the location database includes a plurality of addresses including the address, and a type of location associated with the address, and wherein, the type of location corresponds to a type of business of the location.

13. The computer program product of claim 8, wherein the location event may be selected from the group consisting of: Dwell-in a boundary of the location; Entry-into the boundary; and Exit-from the boundary, and wherein the boundary is a geometrical enclosure around the location including the location.

14. The computer program product of claim 8, wherein the notification is preconfigured in a marketing campaign database, and wherein the notification promotes a business transaction according to the type of the location with the confidence score as ascertained by use of the location database.

15. A system comprising:
a memory;
one or more processor in communication with memory; and
program instructions executable by the one or more processor via the memory to perform a method for optimizing a confidence score for a location visited by a user carrying a mobile device, comprising:
obtaining a geographical coordinates of the mobile device, wherein the geographical coordinates indicating a location event in relation with the location and the mobile device;
acquiring an address from the geographical coordinates of the location event;
searching a location database for the address;
analyzing one or more result from the searching;
determining a confidence score indicating a likelihood on a type of the location, based on the analyzing; and
sending a notification for the location to the user, wherein the notification is generated based on the confidence score on the type of the location.

16. The system of claim 15, further comprising:
identifying a place of interest for the user, based on the location and a personalized geofence of the user.

17. The system of claim 16, wherein the personalized geofence of the user is a predefined geometric range from the mobile device, and wherein the place of interest may be determined based on a frequency of visits to the location, a time of the day for the visits, and hours spent on the location.

18. The system of claim 15, the determining comprising:
adjusting the confidence score on the type of the location according to content relevant to the address from the location database, based on ascertaining updates of the location database on the content relevant to the address.

19. The system of claim 15, wherein the location database includes a plurality of addresses including the address, and a type of location associated with the address, and wherein, the type of location corresponds to a type of business of the location.

20. The system of claim 15, wherein the location event may be selected from the group consisting of: Dwell-in a boundary of the location; Entry-into the boundary; and Exit-from the boundary,
wherein the boundary is a geometrical enclosure around the location including the location,
wherein the notification is preconfigured in a marketing campaign database, and
wherein the notification promotes a business transaction according to the type of the location with the confidence score as ascertained by use of the location database.
